(19) United States
(12) Patent Application Publication
(10) Pub. No.: US 2009/0178887 A1
(43) Pub. Date: Jul. 16, 2009

(54) Retractable lifeline safety device

(76) Inventors: Eric William Reeves, Charlotte, NC (US); Wrenn Howard Smith, Huntsersville, NC (US)

Correspondence Address: Patent Law Agency, LLC, 3146 North Verdugo Road, Glendale, CA, 91208-1665, US

(21) Appl. No.: 12/319,857

(22) Filed: Jan. 12, 2009

Related U.S. Application Data
(63) Continuation of application No. PCT/US07/15289, filed on Jul. 10, 2007.
(60) Provisional application No. 60/819,676, filed on Jul. 10, 2006.

(51) Int. Cl. A62B 1/10

(52) U.S. Cl. 182/239

(57) ABSTRACT

A retractable lifeline safety device usable as heights above the ground. The safety device is attached to the structure on which the worker is performing the task, and a lifeline such as a cable is withdrawn from the housing thereof, the end of which is attached to a belt or harness worn by the worker. The cable may be easily drawn out of the housing in response to the worker moving about normally in the appropriate work space, and the cable is automatically drawn back into the housing of the safety device as the worker draws closer thereto. However, should the worker fall, a brake mechanism within the safety device is automatically engaged by a sprocket and pawl system, stopping the worker's descent.

### CROSS REFERENCE TO RELATED APPLICATION(S)

This application is a Continuation Application claiming the benefit of priority of the co-pending International Patent Application No. PCT/US2007/015289, with a filing date of 10 Jul. 2007, which claims the benefit of priority of U.S. Utility Provisional Patent Application No. 60/819,676, filed 10 Jul. 2006, the entire disclosures of all Applications are expressly incorporated by reference in their entirety herein.

### BACKGROUND OF THE INVENTION

1. Field of the Invention

The present invention relates generally to safety devices and methods for fall protection, and more specifically, to safety devices, in an exemplary embodiment, including retractable lifelines, operable for arresting or decelerating the rapid downward movement of a person or object after a fall.

2. Technical Background

Numerous conventional devices and methods, including retractable lifelines, are known to arrest the downward progress of a person or object after the initiation of a fall from a height. In such conventional retractable lifelines a person or object is secured to a predetermined point of a structure such that a risk of injury from a fall is minimized. Typically, if a fall occurs, the person or object secured to the retractable lifeline descends rapidly at the onset, thereby triggering a braking mechanism which, in turn, stops or slows the rate of fall. Further, under normal conditions the person wearing or attached to the device is able to withdraw a cord or cable from a housing thus extending the distance between the person and the secure point on the structure. In addition, the person may retract or rewind the cord or cable back onto the housing thus shortening the distance between himself and the secure point on the structure. This allows the person working to operate at varying distances from the secure point on the structure and does not limit him to a specific, static spot.

In one such conventional, retractable lifeline, a spool assembly having a drum is provided within a housing about which a cord or cable is wound. The lifeline is designed to attach to a secure point on a structure at a predetermined height, the end of the cord or cable attaching to a safety harness worn by a person working at a height either above or below the structure. The drum is operable for rotational movement at a relatively slow rate of speed as the person to which the lifeline is secured causes the cord to extend and/or retract. The lifeline also typically includes a centrifugally actuated brake mechanism which generally consists of one or more pawls mounted inside the housing or on the drum such that the pawls rotate along with the drum as the strap, cord or cable is extended or retracted. The brake mechanism is operable for locking in the event of a fall. Specifically, in the event of a fall, the cord or cable stops extending or slows after the brake mechanism is actuated, thereby preventing injury. The lifeline is also typically provided with a sprocket that is mounted within the housing and is operable for ensuring that the pawls do not contact the cord during use. The sprocket is either stationary or held in frictional engagement with a separate washer or ring that is fixed to the housing, thus preventing the washer or ring from any movement. Thus, while the sprocket may move, its movement is limited to the extent of its frictional relationship to the stationary washer or ring. In addition, a spring or other suitable mechanism may be provided which is designed to continually exert a small force on the drum around which the cord or cable is wrapped in the direction of continually winding the cord or cable around the drum. This force serves to take up slack in the cord or cable when the person is moving toward the secure point on the structure, thus decreasing the distance and decreasing the amount of cord or cable needed to maintain continual connection between the person and the secure point in the structure.

Disadvantageously, conventional retraceable lifelines stuffer from many shortcomings. By way of example, conventional retractable lifelines are typically formed by molding and can require numerous components, thus increasing the overall complexity and costs of manufacture. By way of another example, conventional lifelines may inadvertently lock up if the cable is withdrawn too quickly even though a fall is not occurring. By way of another example, conventional lifelines undesirably have power springs attached to the drum/spool by means of a screw, rivet, or other conventional device. This, in turn, requires that the power spring, and the overall size of the lifeline, to be large enough to accommodate a rivet or the like. By way of another example, conventional housings for lifelines are susceptible to damage from external forces due to their structural design. By way of yet another example, typical retractable lifeline devices have numerous parts/components that are exposed to high levels of potentially damaging forces. Specifically, the frictional forces holding the sprocket and spool assembly in place may cause excessive wear and strain on the other components. Ultimately, this may lead to failure of the device. Also, the pawls in known devices are subject to repetitive striking forces when the brake mechanism is activated and again when the spool is reversed and the pawls are released from the sprocket. By way of another example, known lifelines lack of any warning signal when a lockup is imminent.

### SUMMARY OF THE INVENTION

In view of the shortcomings of current retractable lifelines, a need exists for an improved retraceable lifeline. The present invention is designed to overcome the deficiencies and shortcomings of the devices described above. The present invention is designed to reduce the manufacturing costs and alleviate much of the unnecessary stress on the internal components caused by friction and striking forces.

According to an exemplary embodiment, a retraceable lifeline device is provided that includes a cable wrapped about a rotatable spool which is, in turn, enclosed within a housing. One end of the cable terminates to a fastening mechanism such as a hook, eye, or the like for attaching to or securely clipping to a safety harness worn by a worker or climber or stationary attachment point. The opposed end is fixed to the spool upon which the cable is wound about. In exemplary embodiments, the housing is secured to an elevated surface or the worker (not shown), by a swivel assembly which allows the retractable line to freely rotate while maintaining engagement with the surface.

Contained within the housing, a spool assembly having a spool/drum is supported by an axle. The axle is provided with a slot for receiving a portion of a power spring. A power spring assembly is mounted within the housing and contains the power spring. The inner end of the power spring terminates in an axle hook that fits securely within the slot in the axle. The exterior end of the power spring terminates in a spool hook that fits into a hook relief and a spool slot. The power spring has a band that holds the power spring together. A spring cover attaches to the spool such that the spring cover encases the power spring within the spool by conventional means.

The end of the cable that attaches to the hook forms a loop by looping back on itself and being secured by at least one, but preferably two duplex ferrules. Such loop attaches to the hook and protrudes from a cushion. The opposite end of the cable is secured inside the housing to the spool by means of a cable stop. A portion of the cable, the reserve cable, is fixed to a spool drum about which the cable winds and unwinds. On the end of the reserve cable opposite to the cable stop, a clamp secures the reserve cable to the spool drum. The clamp is preferably attached to the spool drum by a clamp screw accessed from the exterior of the spool drum. The clamp screw attaches to a clamp flat. In the event of a fall in which the cable extension reaches the reserve cable, the screw, the screw hole threads, or the clamp flat breaks and allows the reserve cable to be withdrawn from the spool, thus providing additional time to slow the rate of extrusion of the cable from the spool.

On the lower end of the housing where the cable exits, a cable guide separates the cable from the body of the housing and prevents the cable from rubbing against the housing while it is withdrawn and retracted. The cable guide has a cable guide tab protruding around its perimeter for engagement with the housing. The cable guide tab is held in place, or nested, within the housing by a cable guide mount.

Within the spool and adjacent to the power spring are two pawls rotatably mounted on corresponding pawl axles. The pawls are held on the pawl axles by pawl washers and snap rings. The rotation of the pawls are arrested by pawl springs that attach the tip of the pawls. The pawl springs exert enough force on the ends of the pawls to keep their position stationary. Pawls stops are provided to limit the extent of the rotation of the pawls. A pair of spring guards are attached to the axle in opposite relation between the pawls such that the spring guards provide protection to the pawl springs.

Inside the housing is provided at least one spring washer, a friction ring and a sprocket. On a side of the sprocket opposite the friction ring is provided at least one of washers and a pressure plate. The pressure plate is held against the washers and secured to the housing by a plurality of pressure plate screws. The pressure of the sprocket against the friction ring creates the drag friction needed to arrest the rotating spool.

The sprocket has at least one tooth with a terminal end disposed at a predetermined tooth ramp angle such that the tooth protrudes slightly further toward the pawls. During normal operation of the retractable line the pawls do not engage the sprocket or contact the tooth. As the centrifugal force-begins to rotate the pawls about the axles, the tips of the pawls will contact the tooth causing all audible click.

In other exemplary embodiments, the housing is strengthened by inclusion of case indents. The case indents are generally comprised of the indent web wall and the indent vertical wall. The case indents follow the contour of the spool.

In all exemplary embodiments, the retractable lifeline is easier to manufacture and maintain. Further, the present invention provides an audible and tactile indicator of impending lockup by utilizing a sprocket with one or more distinct teeth. Normally, the sprocket consists of a plurality of teeth each identical and spaced so the pawls may enter into a root area thereby engaging the sprocket. The present invention alters a tooth on the sprocket to extend slightly beyond the normal teeth. A tooth ramp on the top of this odd tooth is provided at a predetermined tooth ramp angle such that as the pawls begin to rotate on the pawl axles, the end of the pawl will contact the tooth ramp and deflect off. Thus the pawl will strike the tooth ramp but not engage the root area and not engage the sprocket. The pawl contacting the tooth ramp produces an audible signal and a tactile signal which alerts the user that lockup is imminent. In the event of a fall, the velocity of the pawls is such that the pawl will enter the root area and engage the sprocket. Still further, the exemplary embodiments of the present invention provide a retractable lifeline that has power springs attached to the drum/spool by means of a band, thereby permitting a smaller size than that of conventional devices. Still further, the exemplary embodiment of the present invention provides a retractable lifeline which has a housing constructed with case indents, thereby providing a stronger and lighter device. Still further, the exemplary embodiments disclose an assembly which includes pawls that are resistant to damage via their connection to the spool assembly.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description present exemplary embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the detailed description, serve to explain the principles and operations thereof.

### BRIEF DESCRIPTION OF THE DRAWINGS

These and other features, aspects and advantages of the present invention are better understood when the following detailed description of the invention is read with reference to the accompanying drawings, in which:—

FIG. 1 is an exploded perspective view of a retractable lifeline constructed in accordance with an exemplary embodiment of the present invention.

FIG. 2 is an exploded perspective view of a spool assembly of the retractable lifeline of FIG. 1 wherein the orientation of pawls is shown.

FIG. 3 is a cross-sectional view of a cable guide of the retractable lifeline of FIG. 1 showing the preferred arrangement of a cable guide mount and a cable guide tab.

FIG. 4 is a perspective view of a power spring and its installation within the spool assembly of FIG. 1, showing a band and a band hole.

FIG. 5 is a perspective view of the spool assembly showing a reserve cable.

FIG. 6 is a cross-sectional view of the retractable lifeline with the housing removed.

FIG. 7 is a cross-sectional view of an exemplary embodiment of the lockup indicator showing one pawl in normal operating position and one pawl in lockup position with the sprocket.

FIG. 8 is a cross-sectional view of another exemplary embodiment of the lockup indicator showing one pawl in normal operating position and one pawl in lockup position with the sprocket.

FIG. 9 is a perspective view of a Belleville washer used in the exemplary embodiments of the retractable lifeline of the present invention.

FIG. 10 is a cross-sectional view of an exemplary embodiment of the housing of the retractable lifeline of the present invention wherein the housing is constructed with case indents.

### DETAILED DESCRIPTION OF EXEMPLARY EMBODIMENTS

The present invention will now be described more fully hereinafter with reference to the accompanying drawings in which exemplary embodiments of the invention are shown. However, this invention may be embodied in many different forms and should not be construed as limited to the embodiments set forth herein. These exemplary embodiments are provided so that this disclosure will be both thorough and complete, and will fully convey the scope of the invention to those skilled in the art. Like reference numbers refer to like elements throughout the various drawings. Further, as used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise.

In the exemplary embodiments described herein, the present invention provides a retractable lifeline safety device operable for arresting or decelerating the rapid downward movement of a person or object after a fall. The exemplary embodiments of the invention also provide a retractable lifeline that is easier and more cost efficient to manufacture and that signals a user when a lockup is about to occur. Further, the exemplary embodiments of the present invention provide a retractable lifeline warns the wearer of an impending lock up of the cable if the same is being withdrawn too quickly. Still further, the exemplary embodiments of the present invention provide a retractable lifeline that has power springs attached to the drum/spool by means of a band eliminating the need for bulky fasteners, thereby permitting a smaller size than that of conventional devices. Still further, the exemplary embodiment of the present invention provide a retractable lifeline which has a housing constructed with case indents, thereby providing a stronger and lighter device. Still further, the exemplary embodiments disclose an assembly which includes pawls that are resistant to damage via their connection to the spool assembly.

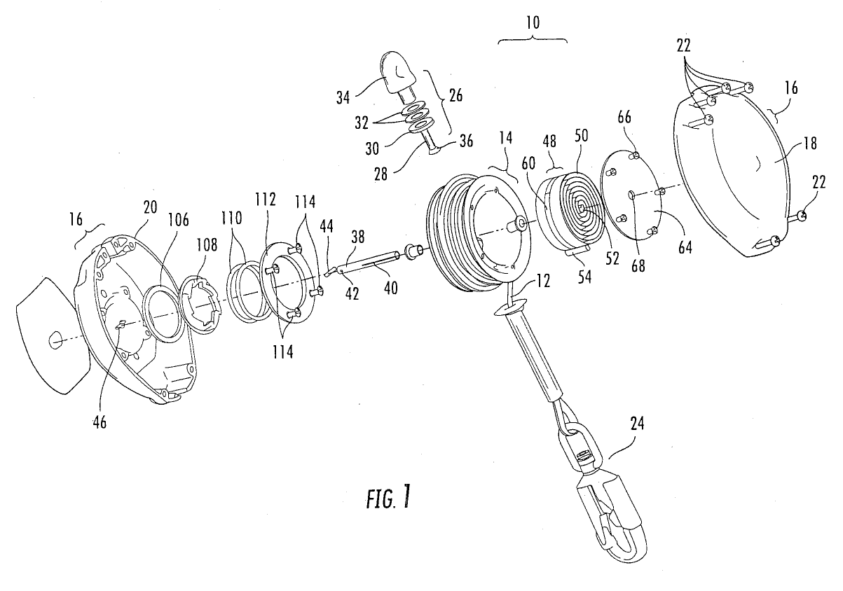

Referring now to the drawings, and specifically to FIG. 1, there is shown an exemplary embodiment of a retractable lifeline constructed in accordance with the principles of the current invention and designated generally as 10. The retractable lifeline device 10 is generally includes a spool assembly having a cable 12 wrapped around a rotatable spool or drum 14 which is, in turn, enclosed within a housing 16. The housing 16 is formed by two complimentary halves, 18 and 20, being removably joined together, the first half 18 having a spring which securely attaches to a sprocket contained within the opposed half 20, thus forming an enclosure for the spool 14 and other movable components of the retractable lifeline 10. In the exemplary embodiment illustrated, the spring side portion 18 and the sprocket side portion 20 of the housing 16 are held together by at least one, but preferably a plurality of bolts 22, However, it will be understood by those skilled in the art that any suitable means for removably securing the halves 18 and 20 together may be employed, including, but not limited to screws, ties, seals and the like. One end of the cable 12 terminates to a fastening mechanism 24 such as a hook, eye, or the like for attaching to or securely clipping to a safety harness worn by a worker or climber. The opposed end is fixed to the spool 14 upon which the cable 12 is wound about.

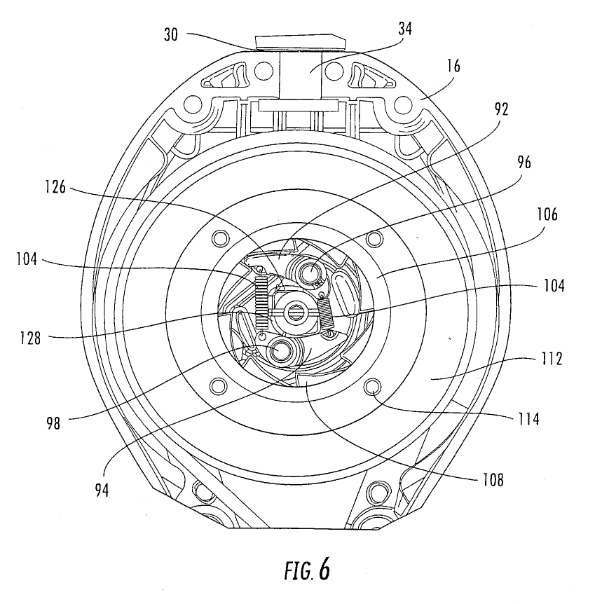

The housing 16 is secured to an elevated surface or a person (not shown) by a swivel assembly 26 having a swivel bolt 28 with a swivel base 30, the swivel bolt 28 being rotatably engaged with one or more bearing washers 32 and a swivel body 34. In exemplary embodiments, the swivel assembly 26 securely connects to an elevated surface (not shown) and allows the retractable line 10 to freely rotate while maintaining engagement with the surface. The end of the swivel bolt 28 opposite the swivel base 30 has an enlarged portion 36 that is contained within and held by the housing 16, as best shown in FIG. 6, thus securing the retractable line 10 to the swivel assembly 26. When the lifeline 10 is secured to an elevated point by the swivel assembly 26, it may twist and rotate about the swivel assembly 26 to reduce any wind of the cable 12 caused by the rotation. In exemplary embodiments, the lifeline 10 may also be provided with a plurality of washers or needle/roller type bearings in the swivel assembly 26 operable for reducing the frictional forces which may be exerted on the swivel assembly 26. Thus, the wear or damage to the swivel assembly 26, cable 12 or the housing 16 is reduced, thereby extending the useable life of the retractable line 10.

Contained within the housing 16, the spool 14 is supported by an axle 38 horizontally supported by and spanning the distance between the spring side portion 18 and the sprocket side portion 20 of the housing 16. The axle 38 has a slot 40 running lengthwise from the spring side portion 18 to approximately the middle of the axle 38 for receiving a portion of a power spring 50. The end of the axle 38 nearest the sprocket side portion 20 of the housing 16 has rotation-prevention means, such as a hole 42 through which a pin 44 is inserted. The pin 44 nests securely within a pin slot 46 on the sprocket side portion 20 of the housing 16 such that the pin 44 and axle 38 are prevented from rotating during normal operation when subjected to centrifugal forces as the cable 12 is withdrawn from and retracted into the housing 16.

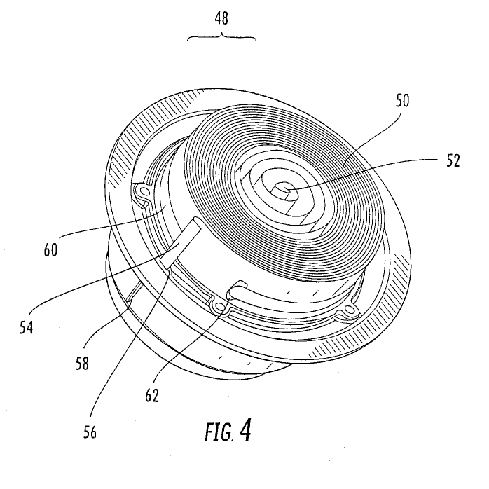

A power spring assembly 48 operable for biasing the spool 14 to rotate in the retractable direction, an exploded view of which is illustrated in FIG. 4, is mounted adjacent to the spring side portion 18 and contains the power spring 50. The inner end of the power spring 50 terminates in an axle hook 52 that fits securely within the slot 40 in the axle 38. The exterior end of the power spring 50 terminates in a spool hook 54 that fits into a hook relief 56 and a spool slot 58. The power spring 50 has a band 60 that holds the power spring 50 together. The band 60 passes around the power spring 50 and through a band hole 62 in the end of the power spring 50 such that the band 60 forms a continuous, unbroken loop surrounding the power spring 50. A spring cover 64 attaches to the spool assembly 14 such that the spring cover 64 encases the power spring 50 within the spool 14 by conventional means 66 such as, for example, screws. The spring cover 64 has a cover hole 68 in its center such that the axle 38 passes through the spring cover 64 and into the spring side portion 18 of the case 16. Thus, the spring cover 64 and spool 14 are free to rotate around the axle 38. The use of the band 60 eliminates a stress concentration on the edge of the conventional weld which is used for the power spring. Further, by using the band 60, the power spring may be more compact in size. This is a specific advantage over conventional lifelines which typically use a rivet or screw to hold the band and/or the power spring together.

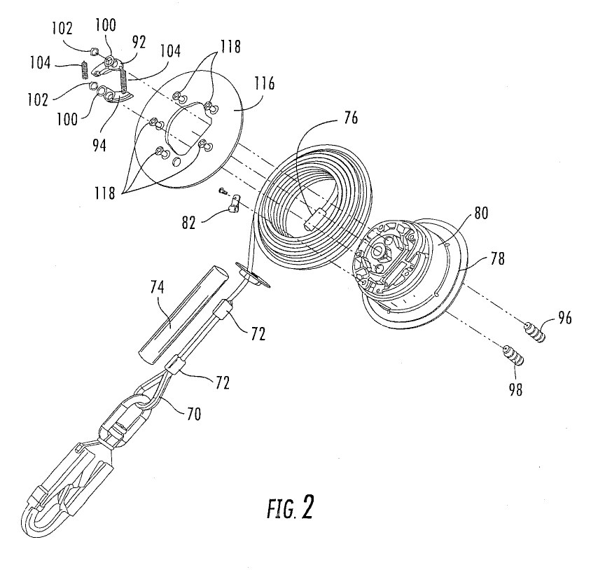

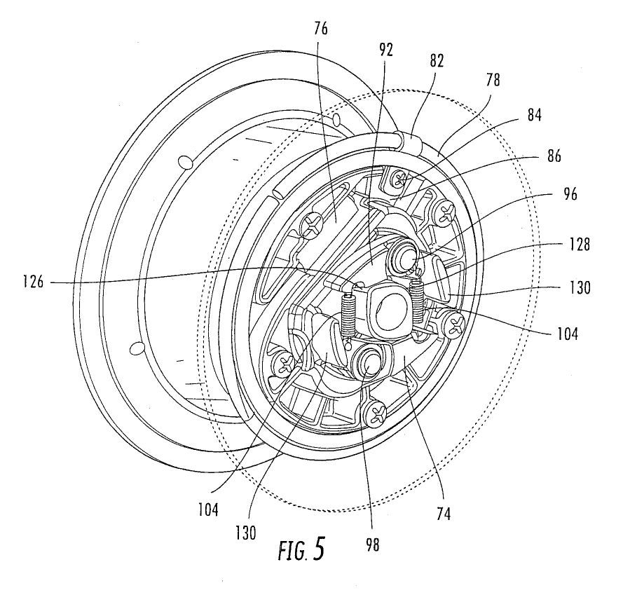

Referring now to FIG. 2-5, it can be seen that the end of the cable 12 that attaches to the hook 24 forms a loop 70 by looping back on itself and being secured by at least one, but preferably two duplex ferrules 72. Such loop attaches to the hook 24 and protrudes from a cushion 74 that comprises a cylindrical tube encasing the duplex ferrules 72. Such cushion 74 can absorb shock in the event that the retraction of the cable 12 reaches a velocity that would cause impact damage to the housing 16. The opposite end of the cable 12 is secured inside the housing 16 to the spool 14 by means of a cable stop 76. A portion of the cable 12, the reserve cable 78, is fixed to a spool drum 80 about which the cable 12 winds and unwinds. The cable stop 76 secures the end of the cable 12 to the spool drum 80 creating the terminal end of the reserve cable 78. On the end of the reserve cable 78 opposite to the cable stop 76, a clamp 82 secures the reserve cable 78 to the spool drum 80. Advantageously and distinct from conventional lifelines, the clamp's flat portion is oriented to allow easy access to the screw without having to move the cable 12. During normal operation of the retractable line 10, the cable 12 may be withdrawn up to the point at which the clamp 82 engages the cable 12. The clamp 82 is preferably attached to the spool drum 80 by a clamp screw 84 accessed from the exterior of the spool drum 80. However, it will be appreciated and understood by those skilled in the art that any means for securing the clamp 82 to the spool drum 80 may be used. The clamp screw 84 attaches to a clamp flat 86. The clamp flat 86, screw or hole threads, is sized to break off at a predetermined load. Thus, in the event of a fall, the clamp flat 86 breaks and allows the reserve cable 78 to be withdrawn from the spool 14, thus providing additional time to slow the rate of extrusion of the cable 12 from the spool 14 and slowing the rate of descent. In addition, the power spring 50 may be sized to have just enough turning capacity to extend and retract only the cable 12 that does not include the reserve cable 78. When the clamp 82 releases the reserve cable 78 and it is withdrawn, the spool 14 continues to rotate which will cause the pin to break and allow the spool 14 to release the reserve cable 78 even though the power spring 50 has reached the limit of its extension turns.

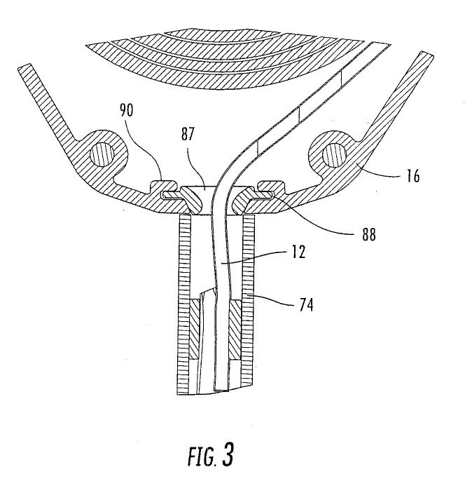

Referring now specifically to FIG. 3, it can be seen that on the lower end of the housing 16 where the cable 12 exits, a cable guide 87 separates the cable 12 from the body of the housing 16 and prevents the cable 12 from rubbing against the housing 16 while it is withdrawn and retracted. The cable guide 87 has a cable guide tab 88 protruding around its perimeter for engagement with the housing 16. The cable guide tab 88 is held in place, or nested, within the housing 16 by a cable guide mount 90. This has the advantage of allowing for molding the cable guide 87 with only one pull direction instead of two pull directions, as required by conventional lifelines. In other exemplary embodiments, the lifeline 10 may be provided with cable guide mounts extending along a back wall of the housing between the mounts. This would extend the mounts all the way around the cable guide.

Within the spool 14 and adjacent to the power spring 50 is a braking system having a centrifugal clutch mechanism. In exemplary, embodiments, the centrifugal clutch mechanism includes at least one, but preferably two pawls, pawl A 92 and pawl B 94. In exemplary embodiments, pawls A 92 and B 94 are mounted on pawl axle A 96 and pawl axle B 98, respectively. Pawls A 92 and B 94 are held on the pawl axle 96 and 98 by pawl washers 100 and snap rings 102. Pawls A 92 and B 94 are preferably, rotatably mounted on pawl axle A 96 and pawl axle B 98 such that pawl A 92 and pawl B 94 can freely rotate. In exemplary embodiments, the rotation of pawl A 92 and pawl B 94 is arrested by pawl springs 104 that attach the tip of pawl A 92 to the end of pawl B 94 and the tip of pawl B 94 to the end of pawl A 92. The pawl springs 104 exert enough force on the ends of pawl A 92 and pawl B 94 to keep pawl A 92 and pawl B 94 in a stationary position, disposed inwardly toward each other and the axle 38. During normal operating conditions, pawl A 92 and pawl B 94 do not rotate about the axles and thus cable 12 is withdrawn and retracted without interruption. A pawl stop A 126 and a pawl stop B 128 are placed adjacent to the axle 38 to limit the extent of the rotation of pawl A 92 and pawl B 94. Pawl stop A 126 limits rotation of pawl A 92 and pawl B 94 inward to prevent the pawl springs 104 from being compressed and to decrease the amount of rotation available for pawl acceleration. Likewise, pawl stop B 128 prevents pawl A 92 and pawl B 94 from overextending during production when a sprocket may not be present. The pawl stops further prevent damage to the pawl springs from spring surge by limiting the distance the pawl could accelerate. A pair of spring guards 130 are attached to the axle 38 in opposite relation between pawl A 92 and pawl B 94 such that the spring guards 130 provide protection to the pawl springs 104. Specifically, the spring guards 130 are used to prevent the pawl springs from being replaced without removing the pawls from the pawl axles. Attempting to replace the pawl springs while the pawls are still assembled causes excessive trauma to the pawl springs.

Inside the sprocket side portion 20 of the housing 16 is a friction ring 106 that nests against the sprocket side portion 20 of the housing 16. Adjacent to the friction ring 106 is a sprocket 108. On the opposite side of the sprocket 108 from the friction ring 106 is at least one of the washers 110 and the pressure plate 112. The pressure plate 112 is held against the washers 110 and secured to the sprocket side portion 20 of the housing 16 by a plurality of pressure plate screws 114. The pressure plate screws 114 securely attach the pressure plate 112 to the sprocket side portion 20 of the housing 16 and prevent the pressure plate 112 from moving. The pressure plate screws 114 are tightened to a predetermined load, thereby pressing the pressure plate 112 into the washers 110, effectively exerting a compression force on the washers 110, the sprocket 108, and the friction ring 106. It will be understood by those skilled in the art that the friction components of the present invention are what slows and stops descent of a worker or object in the event of a fall. The pressure of the sprocket 108 against the friction ring 106 creates the drag friction needed to arrest the rotating spool 14. Spring loading the sprocket creates a more consistent friction between the sprocket and the friction ring. Using washer type springs which are approximately the diameter of the sprocket allows for a more compact mechanism. Such washer type springs are known as wave washers and Belleville washers.

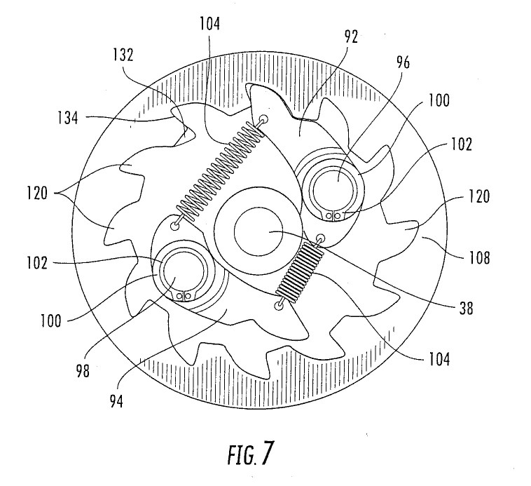

During normal operation of the retractable line 10, pawl A 92 and pawl B 94 rotate freely within the friction ring 106, sprocket 108, washers 110, and pressure plate 112. This is shown in FIG. 7 by pawl B 94 and its position in relation to the sprocket 108. A sheave 116 attaches to the spool drum 80 by means of a plurality of sheave screws 118 and prevents the cable 12 from contacting the washers 110, the sprocket 108, and the friction ring 106. In the event of a fall, the spool 14 will initially rotate at a high rate of speed as the cable 12 is rapidly withdrawn from the retractable line 10. As a result of this high-speed withdrawal of the cable 12, the spool 14, including pawl A 92 and pawl B 94 will rapidly rotate around the axle 38. This rapid rotation creates a centrifugal force upon the tip of pawl A 92 and pawl B 94 of such magnitude as to overcome the compression force of the pawl springs 104. As the centrifugal force overcomes the compression force of the pawl springs 104, pawl A 92 begins to rotate around pawl axle A 96 and pawl B 94 begins to rotate around pawl axle B 98. As pawl A 92 and pawl B 94 continue to rotate on pawl axle A 96 and pawl axle B 98 respectively, the tips of pawl A 92 and pawl B 94 will come into contact with the sprocket 108. As pawl A 92 and pawl B 94 contact the sprocket 108, the tips of pawl A 92 and pawl B 94 will each slide into one of a plurality of root areas 120 of the sprocket 108. This is best shown in the exemplary embodiment of FIG. 7 by the position of pawl A 92. Once pawl A 92 and pawl B 94 have engaged the sprocket 108 and are nested in the root areas 120, the rotational force of the spool assembly 14 is transferred to the sprocket 108. This causes the sprocket 108 to rotate against the washers 110 and the friction ring 106. The frictional resistance caused by the compression force from the pressure plate 112 compressing the washers 110, friction ring 106, and sprocket 108 causes the sprocket 108 to slow its rotation. This, in turn, slows the rotation of pawl A 92 and pawl B 94 and thus slows the rotation of the spool 14. As the rotation of the spool 14 is slowed and slopped, the withdrawal of the cable 12 from the retractable line 10 is slowed and stopped and, thus, the fall is arrested.

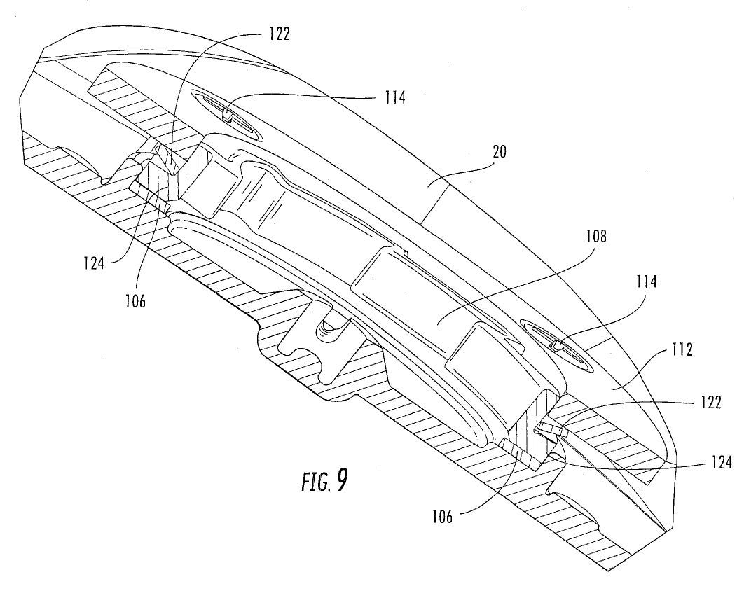

As seen best in FIG. 9, another exemplary embodiment is available that makes use of at least one washer-type spring, such as a wave washer and/or a Belleville washer 122. In this embodiment, the sprocket 108 has a shoulder 124 around its perimeter. The pressure plate 112 rests directly above the shoulder 124 and a plurality of Belleville washers 122 separates the pressure plate 112 from the shoulder 124. The pressure plate screws 114 are tightened to cause the pressure plate 112 to compress the Belleville washers 122 against the sprocket 108. This compression force acts to slow and stop the rotation of the sprocket 108 in the event of a fall. A third embodiment consists of a Belleville washer with or without another washer that bears directly on the sprocket or on a shoulder of the sprocket. The shoulder of the sprocket would provide a radius and act to spread out the contact area of the Belleville washer on the sprocket.

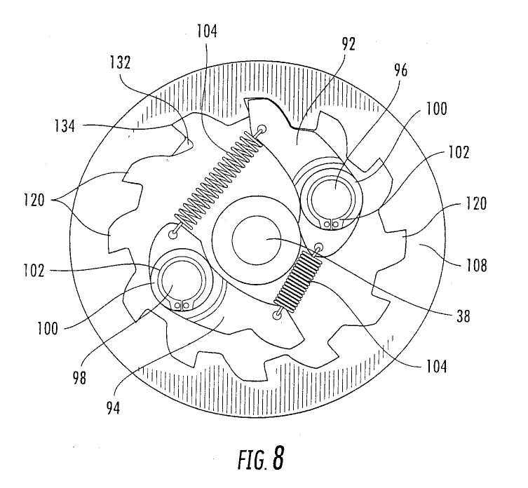

Referring back to FIG. 7, the sprocket 108 has a tooth 132 with a terminal end disposed at a predetermined tooth ramp angle 134 such that the tooth 132 protrudes slightly further toward pawl A 92 and pawl B 94. During normal operation of the retractable line 10 pawl A 92 and pawl B 94 do not engage the sprocket 108 or contact the tooth 132. As the centrifugal force begins to rotate pawl A 92 and pawl B 94 on pawl axle A 96 and pawl axle B 98, the tips of pawl A 92 and pawl B 94 will contact the tooth 132 causing an audible click. The tooth 132 is inclined at the tooth ramp angle 134 such that pawl A 92 and pawl B 94 will bounce off the tooth 132, missing the root area 120 and failing to engage the sprocket 108. As the velocity and centrifugal force increases, pawl A 92 and pawl B 94 will rotate further and will overcome the tooth ramp angle 134 and enter the root area 120 thus engaging the sprocket 108. Referring now to FIG. 8, another exemplary embodiment of the sprocket 108 is shown. As shown, the tooth 132 is provided with a distinct configuration from that illustrated in FIG. 7. Specifically, the tooth 132 is provided with a ramped surfaced having a generally planar tip.

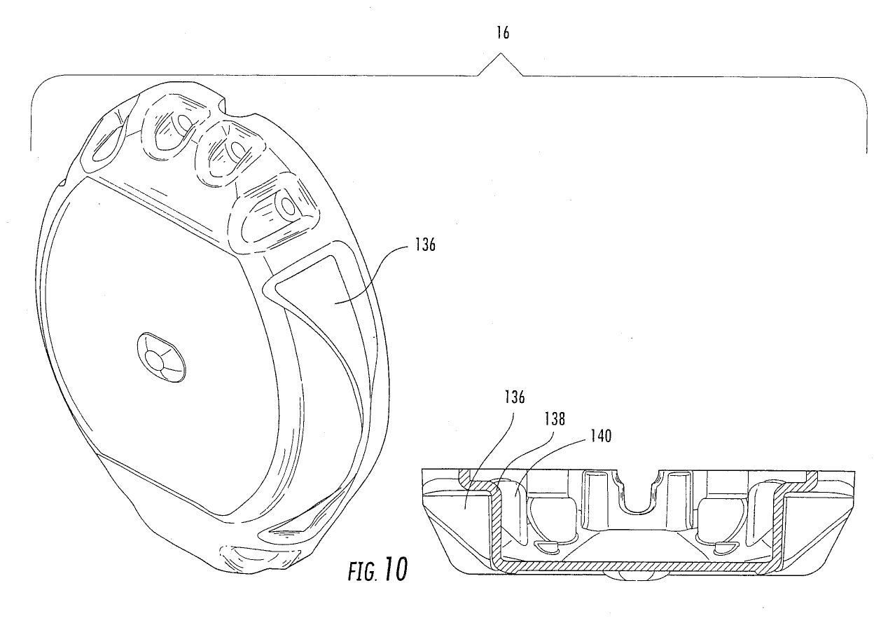

The housing 16 is strengthened by inclusion of case indents 136 as seen on FIG. 10. In exemplary embodiments, the case indents 136 are generally comprised of the indent web wall 138 and the indent vertical wall 140. The case indents 136 follow the contour of the spool 14. These case indents 136 strengthen the housing 16 and add little weight. Further, the case indents 136 do not decrease the clearance for the internal components because they follow the circular outline of the spool 14.

The embodiments described above provide advantages over conventional retractable lifelines and associated methods of manufacture. It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

What is claimed:

1. A retractable lifeline, comprising:
a housing adapted to be connected to a person or object, the housing having two complimentary halves which are removably joined together;
a spool assembly mounted within the housing and having a rotatable drum supported by an axle and a cable adapted to be wound about the drum in a retractable direction such that the one end of the cable is fixed to the drum and the opposed end of the cable extends outward from the housing;
a spring attached to the spool assembly for biasing the drum to rotate in the retractable direction, the spring being attached to the drum and held in position by a band; and
a braking mechanism for controlling the rate of rotation of the drum, the braking mechanism including a sprocket, a centrifugal clutch and a friction ring, the centrifugal clutch comprising at least one pawl mounted on an inner wall of the housing and pivotable into engagement with the sprocket in response to a predetermined rate of rotation of the drum and at least one pawl spring biasing the at least one pawl away from engagement with the sprocket when the predetermined rate of rotation of the drum is less than a predetermined value.

2. The retractable lifeline of claim 1, wherein the housing further includes at least one indent along a surface of the housing.

3. The retractable lifeline of claim 1, wherein the housing further comprises at least one cable guide for preventing the cable from contacting the housing when the cable is being withdrawn, the cable guide having a cable guide tab protruding around its perimeter for engagement with the housing.

4. The retractable lifeline of claim 3, wherein the cable guide tab is held in place by a cable guide mount.

5. The retractable lifeline of claim 1, wherein the centrifugal clutch further comprises at least one pawl stop for limiting the extent of the rotation of the at least one pawl and at least one spring guard.

6. The retractable lifeline of claim 1, wherein the sprocket is provided with at least one tooth with a terminal end disposed at a predetermined tooth ramp angle such that the tooth protrudes slightly further toward the at least one pawl.

7. The retractable lifeline of claim 1, wherein a length of the cable is fixed to the drum by a clamp having a screw designed to break upon a predetermined load.

8. A retractable lifeline for arresting or decelerating the rate of speed of a person or object during a fall, comprising:
a housing, the housing having two complimentary halves which are removably joined together;
a drum rotatably mounted within the housing, the drum being supported by an axle extending through the housing;
a cable adapted to be wound about the drum in a retractable direction such that the one end of the cable is fixed to the drum and the opposed end of the cable extends outward from the housing, the cable capable of being unwound from around the drum in response to the drum being rotated in a direction opposite of the retractable direction;
a spring attached to the drum of the drum for biasing the drum to rotate in the retractable direction, the spring being attached to the drum and held in position by a band;
a fastening mechanism secured to the outward extending end of the cable for attachment to a structure;
a braking mechanism for controlling the rate of rotation of the drum, the braking mechanism including a sprocket, a centrifugal clutch and a friction ring; and
wherein the centrifugal clutch includes at least one pawl mounted on an inner wall of the housing and pivotable into engagement with the sprocket in response to a predetermined rate of rotation of the drum and at least one pawl spring biasing the at least one pawl away from engagement with the sprocket when the predetermined rate of rotation of the drum is less than a predetermined value.

9. The retractable lifeline of claim 8, wherein the housing further includes at least one indent along a contour of the housing.

10. The retractable lifeline of claim 8, wherein the housing further comprises at least one cable guide for preventing the cable from contacting the housing when the cable is being withdrawal, the cable guide having a cable guide tab protruding around its perimeter for engagement with the housing.

11. The retractable lifeline of claim 10, wherein the cable guide tab is held in place by a cable guide mount.

12. The retractable lifeline of claim 8, wherein the centrifugal clutch further includes at least one pawl stop and at least one spring guard for limiting the extent of the rotation of the at least one pawl.

13. The retractable lifeline of claim 8, wherein the sprocket further comprises at least one tooth with a terminal end disposed at a predetermined tooth ramp angle such that the tooth protrudes slightly further toward the at least one pawl.

14. The retractable lifeline of claim 8, wherein a length of the cable is fixed to the drum by a clamp designed to break upon a predetermined load.

15. A retractable lifeline, comprising:
a housing adapted to be connected to a person or object, the housing having two complimentary halves which are removably joined together;
a spool assembly mounted within the housing and having a rotatable drum supported by an axle and a cable adapted to be wound about the drum in a retractable direction;
a spring attached to the spool assembly for biasing the drum to rotate in the retractable direction, the spring being attached to the drum and held in position by a band;
a braking mechanism for controlling the rate of rotation of the drum, the braking mechanism including a sprocket, a centrifugal clutch and a friction ring, the centrifugal clutch including at least one pawl mounted on an inner wall of the housing and pivotable into engagement with the sprocket in response to a predetermined rate of rotation of the drum and at least one pawl spring biasing the at least one pawl away from engagement with the sprocket when the predetermined rate of rotation of the drum is less than a predetermined value; and
wherein when the predetermined rate of rotation is greater than the predetermined value, the sprocket and friction ring of the braking mechanism engage each other such that the rotation of the drum decelerates to a stop.

16. The retractable lifeline of claim 15, wherein one end of the cable is fixed to the drum and the opposed end of the cable extends outward from the housing for attachment to a structure.

17. The retractable lifeline of claim 15, wherein the housing further comprises at least one cable guide for preventing the cable from contacting the housing when the cable is being withdrawn, the cable guide having a cable guide tab protruding around its perimeter for engagement with the housing.

18. The retractable lifeline of claim 17, wherein the cable guide tab is held in place by a cable guide mount.

19. The retractable lifeline of claim 15, wherein the centrifugal clutch further comprises at least one pawl stop for limiting the extent of the rotation of the at least one pawl.

20. The retractable lifeline of claim 15, wherein the sprocket is provided with at least one tooth with a terminal end disposed at a predetermined tooth ramp angle.
